(19) United States
(12) Patent Application Publication
(10) Pub. No.: US 2011/0296329 A1
(43) Pub. Date: Dec. 1, 2011

(54) ELECTRONIC APPARATUS AND DISPLAY CONTROL METHOD

(75) Inventor: Kei TANAKA, Ome-shi (JP)

(73) Assignee: KABUSHIKI KAISHA TOSHIBA, Tokyo (JP)

(21) Appl. No.: 13/117,808

(22) Filed: May 27, 2011

(30) Foreign Application Priority Data
May 28, 2010 (JP) 2010-123533

(51) Int. Cl. G06F 3/048

(52) U.S. Cl. 715/769

(57) ABSTRACT

According to one embodiment, an electronic apparatus includes a first touch screen display, a second touch screen display, a detector and a moving module. The detector is configured to detect a touch operation, which indicates a moving direction of a first object displayed on the first touch screen display. The moving module is configured to move a display position of the first object within a region combined a first screen region of the first touch screen display with a second screen region of the second touch screen display, in accordance with the moving direction indicated by the touch operation detected by the detector.

### CROSS-REFERENCE TO RELATED APPLICATIONS

This application is based upon and claims the benefit of priority from Japanese Patent Application No. 2010-123533, filed May 28, 2010, the entire contents of which are incorporated herein by reference.

### FIELD

Embodiments described herein relate generally to an electronic apparatus including a touch screen display, and a display control method.

### BACKGROUND

Conventionally, there is known a multi-display system which can move a window between displays by a simple operation. In this multi-display system, a plurality of display positions of the window are preset, and the respective display positions are called by clicking icons on the screen. Thereby, the position of the window is set.

However, in the prior art, an additional setting needs to be executed in advance, for example, when the window is to be moved to a position which has not been preset as a display position. In addition, since the movement of the window occurs by clicking the icon, it is not easily understandable to which position the window will move.

Thus, there has been a demand for a technique which can move an object, such as a window, which is displayed on a display, by a simple operation which enables intuitive understanding of a destination of movement of the object.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the external appearance of an electronic apparatus according to an embodiment;

FIG. 2 is an exemplary view showing an example of a display screen of a personal computer in the embodiment;

FIG. 3 is an exemplary block diagram showing the system configuration of the personal computer in the embodiment;

FIG. 4 is an exemplary block diagram showing the functional structure of a display control program in the embodiment;

FIG. 5 is an exemplary flow chart illustrating a display control process in the embodiment;

FIG. 6A and FIG. 6B are an exemplary view showing a display example by the display control process in the embodiment;

FIG. 7A and FIG. 7B are an exemplary view showing a display example by the display control process in the embodiment;

FIG. 8A and FIG. 8B are an exemplary view showing a display example by the display control process in the embodiment;

FIG. 9A and FIG. 9B are an exemplary view showing a display example by the display control process in the embodiment;

FIG. 10A and FIG. 10B are an exemplary view showing a display example by the display control process in the embodiment;

FIG. 11A and FIG. 11B are an exemplary view showing a display example by the display control process in the embodiment;

FIG. 12A and FIG. 12B are an exemplary view showing a display example by the display control process in the embodiment;

FIG. 13A and FIG. 13B are an exemplary view showing a display example by the display control process in the embodiment;

FIG. 14A and FIG. 14B are an exemplary view showing a display example by the display control process in the embodiment;

FIG. 15A and FIG. 15B are an exemplary view showing a display example by the display control process in the embodiment;

FIG. 16A and FIG. 16B are an exemplary view showing a display example by the display control process in the embodiment;

FIG. 17A and FIG. 17B are an exemplary view showing a display example by the display control process in the embodiment;

FIG. 18A, FIG. 18B and FIG. 18C are an exemplary view showing a display example by the display control process in the embodiment;

FIG. 19 is an exemplary view showing an example of a title bar of a window in the embodiment; and

FIG. 20 is an exemplary view showing a display example by the display control process in the embodiment.

### DETAILED DESCRIPTION

Various embodiments will be described hereinafter with reference to the accompanying drawings.

In general, according to one embodiment, an electronic apparatus comprises a first touch screen display, a second touch screen display, a detector and a moving module. The detector is configured to detect a touch operation, which indicates a moving direction of a first object displayed on the first touch screen display. The moving module is configured to move a display position of the first object within a region combined a first screen region of the first touch screen display whit a second screen region of the second touch screen display, in accordance with the moving direction indicated by the touch operation detected by the detector.

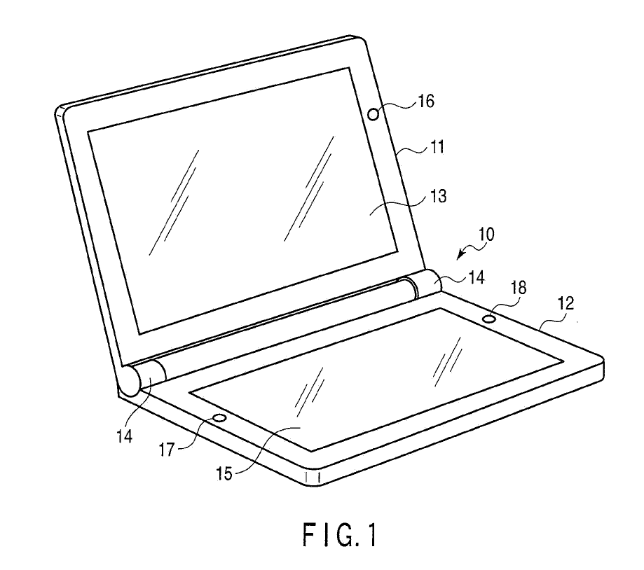

FIG. 1 is an exemplary view showing the external appearance of an electronic apparatus according to the embodiment. This electronic apparatus is realized, for example, as a battery-powerable portable personal computer 10.

FIG. 1 is a perspective view showing the personal computer 10 in a state in which a first unit 11 of the personal computer 10 is opened. The personal computer 10 comprises the first unit 11 and a second unit 12. A touch screen display 13 is built in an upper surface of the first unit 11. The touch screen display 13 is composed of a touch panel 13A and a liquid crystal display (LCD) 13B, and a display screen of the touch screen display 13 is disposed at a substantially central part of the first unit 11.

The touch screen display 13 is configured, for example, such that the touch panel 13A is attached to the surface of the LCD 13B, and the touch screen display 13 can realize display by the LCD 13B and the detection of a touch position which is touched by a pen or a finger. The user can select various objects, which are displayed on the LCD 13B, by using a pen or a fingertip. The objects, which are to be touched by the user, include, for instance, a window for displaying various information, a software keyboard, a software touch pad, icons representing folders and files, menus and buttons. The coordinate data representing the touch position on the display screen is input from the touch panel 13A to the CPU in the computer 10.

The first unit 11 has a thin box-shaped housing. The first unit 11 is rotatably attached to the second unit 12 via a hinge module 14. The hinge module 14 is a coupling module for coupling the first unit 11 to the second unit 12. Specifically, a lower end portion of the first unit 11 is supported on a rear end portion of the second unit 12 by the hinge module 14. The first unit 11 is attached to the second unit 12 such that the first unit 11 is rotatable, relative to the second unit 12, between an open position where the top surface of the second unit 12 is exposed and a closed position where the top surface of the second unit 12 is covered by the first unit 11. A power button 16 for powering on or off the personal computer 10 is provided at a predetermined position of the first unit 11, for example, on the right side of the touch screen display 13.

The second unit 12 is a base unit having a thin box-shaped housing. A touch screen display 15 is built in an upper surface of the second unit 12. The touch screen display 15 is composed of a touch panel 15A and a liquid crystal display (LCD) 15B, and a display screen of the touch screen display 15 is disposed at a substantially central part of the second unit 12.

Two button switches 17 and 18 are provided at predetermined positions on the upper surface of the second unit 12, for example, on both sides of the touch screen display 15. Arbitrary functions can be assigned to the button switches 17 and 18. For example, the button switch 17 is used as a button switch for instructing display of a software keyboard.

The touch screen display 15 is configured, for example, such that the touch panel 15A is attached to the surface of the LCD 15B, and the touch screen display 15 can realize display by the LCD 15B and the detection of a touch position which is touched by a pen or a finger. The user can select various objects, which are displayed on the LCD 15B, by using a pen or a fingertip. The objects, which are to be touched by the user, include, for instance, a window for displaying various information, a software keyboard, a software touch pad, icons representing folders and files, menus, buttons, and an application window. The coordinate data representing the touch position on the display screen is input from the touch panel 15A to the CPU in the computer 10.

The LCD 15B on the second unit 12 is a display which is independent from the LCD 13B of the first unit 11. The LCDs 13 and 15 can be used as a multi-display for realizing a virtual screen environment. In this case, the virtual screen, which is managed by the operating system (OS) of the computer 10, includes a first screen region, which is displayed on the LCD 13B, and a second screen region, which is displayed on the LCD 15B. The first screen region and the second screen region can display arbitrary application windows, arbitrary objects, etc., respectively. In addition, the OS can manage the first screen region and second screen region as a single screen region, and can display an object, which is a display target, at an arbitrary position in this screen region.

In the personal computer 10 of the embodiment, an input operation application for inputting data by a touch operation on the touch screen display 13, 15 by means of a pen or fingertip is provided in place of an input device such as a keyboard or a mouse/touch pad. The input operation application in the embodiment includes, for example, a program which controls the software keyboard and software touch pad.

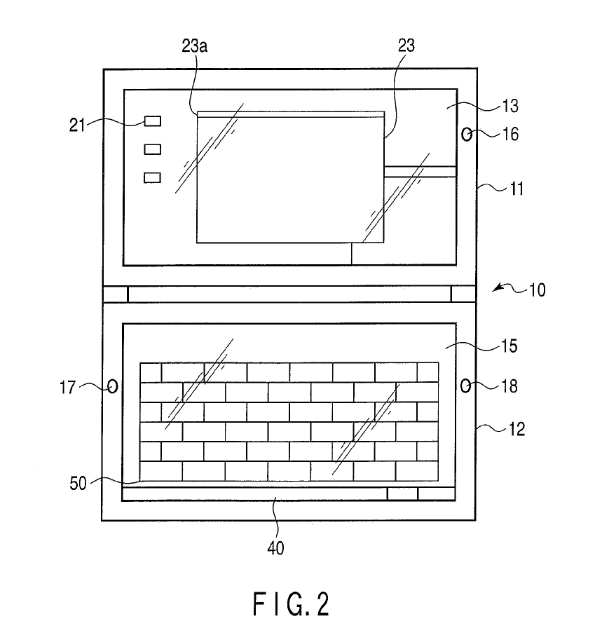

FIG. 2 shows an example of the display screen of the personal computer 10 in this embodiment.

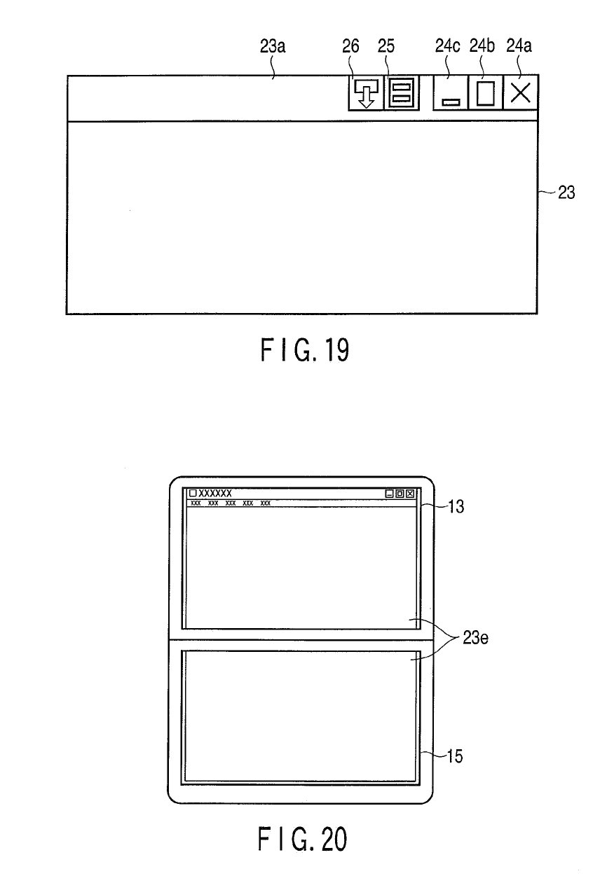

Icons 21 and a window 23 are displayed on the touch screen display 13. A title bar 23a is provided on an upper side of the window 23. A folder name and a file name are displayed on the title bar 23a. In addition, the title bar 23a is provided with buttons for instructing a change of the display mode of the window 23 (e.g. Minimize button, Maximize button and close button), a full-screen display button for displaying the window 23 on the entirety of the touch screen display 13, 15, and a display position change button for changing the display on which the window 23 is displayed (the details will be described later (FIG. 19)). The title bar 23a is touched, for example, for a flick operation or a drag operation, when the display position of the window 23 is changed. The flick operation is such an operation that in the state in which the touch screen display 13, 15 (touch panel 13A, 15A) is touched, the touch position is quickly moved in an arbitrary direction and then the touch is released. The drag operation is such an operation that in the state in which the touch screen display 13, 15 (touch panel 13A, 15A) is touched, the touch position is moved.

The touch screen display 15 displays a software keyboard 50. Aside from the full-screen display mode of the software keyboard 50, as shown in FIG. 2, a plurality of display modes are prepared for the software keyboard 50.

Various objects, such as the icons 21, window 23 and software keyboard 50, which are shown in FIG. 2, can arbitrarily be displayed on either the touch screen display 13 or the touch screen display 15.

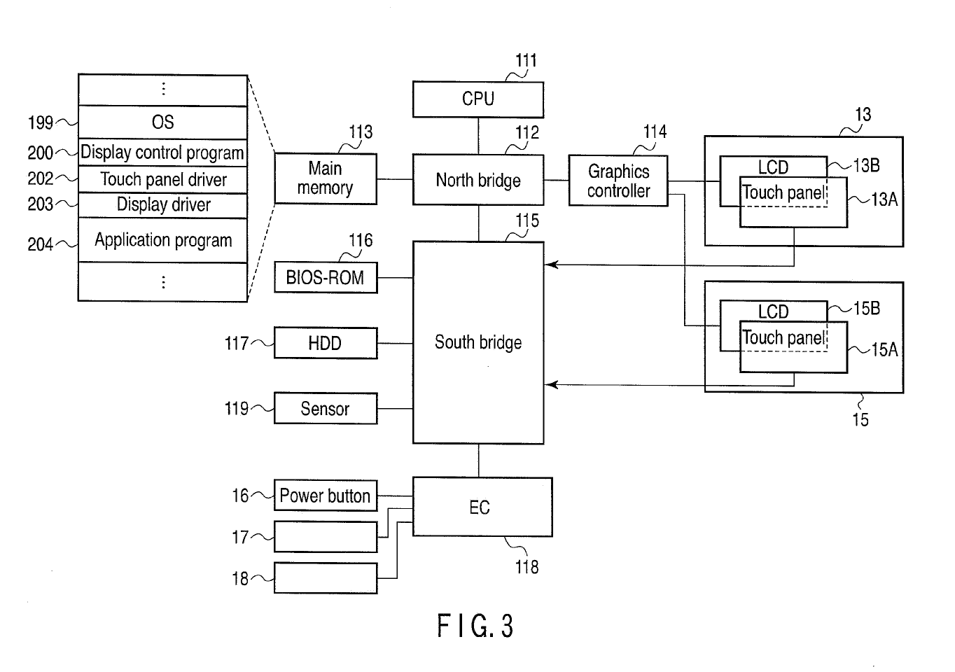

Next, the system configuration of the personal computer 10 in the embodiment is described. FIG. 3 is a block diagram showing the system configuration of the personal computer 10.

The personal computer 10 includes a CPU 111, a north bridge 112, a main memory 113, a graphics controller 114, a south bridge 115, a BIOS-ROM 116, a hard disk drive (HDD) 117, an embedded controller 118, and a sensor 119.

The CPU 111 is a processor which is provided in order to control the operation of the computer 10. The CPU 111 executes an operating system (OS) 199 and various application programs, which are loaded from the HDD 117 into the main memory 113. The application programs include an input operation application for the software keyboard 50, a display control program 200 for controlling display positions of objects, such as the window 23, which are displayed on the LCD 13B, 15B, and other application programs 204 such as a browser program and a word processing program.

The CPU 111 also executes a system BIOS (Basic Input/Output System) which is stored in the BIOS-ROM 116. The system BIOS is a program for hardware control.

Besides, under the control of the OS 199, the CPU 111 executes a touch panel driver 202 which controls the driving of the touch panels 13A and 15A, and a display driver 203 which controls the display on the LCDs 13B and 15B.

The north bridge 112 is a bridge device which connects a local bus of the CPU 111 and the south bridge 115. The north bridge 112 includes a memory controller which access-controls the main memory 113. The graphics controller 114 is a display controller which controls the two LCDs 13B and 15B which are used as a display monitor of the computer 10.

The graphics controller 114 executes a display process (graphics arithmetic process) for rendering display data on a video memory (VRAM), based on a rendering request which is received from CPU 111 via the north bridge 112. A recording area for storing display data corresponding to a screen image which is displayed on the LCD 13B and a recording area for storing display data corresponding to a screen image which is displayed on the LCD 15B are allocated to the video memory. The transparent touch panel 13A is disposed on the display surface of the LCD 13B. Similarly, the transparent touch panel 15A is disposed on the display surface of the LCD 15B.

Each of the touch panels 13A and 15A is configured to detect a touch position on a touch detection surface by using, for example, a resistive method or a capacitive method. As the touch panel 13A, 15A, use may be made of a multi-touch panel which can detect two or more touch positions at the same time. The touch panel 13A, 15A outputs data, which is detected by the user's touch operation, to the south bridge 115.

The south bridge 115 incorporates an IDE (Integrated Drive Electronics) controller and a Serial ATA controller for controlling the HDD 121. The embedded controller (EC) 118 has a function of powering on/off the computer 10 in accordance with the operation of the power button switch 16 by the user. In addition, the south bridge 115 receives data from the touch panel 13A, 15A, and records the data in the main memory 113 via the north bridge 112.

The sensor 119 is configured to detect the attitude of the personal computer 10. The sensor 119 detects whether the personal computer 10 is used in the direction in which the touch screen displays 13 and 15 are arranged in the up-and-down direction or in the direction in which the touch screen displays 13 and 15 are arranged in the right-and-left direction, and notifies the CPU 111 of the detection result via the south bridge 115.

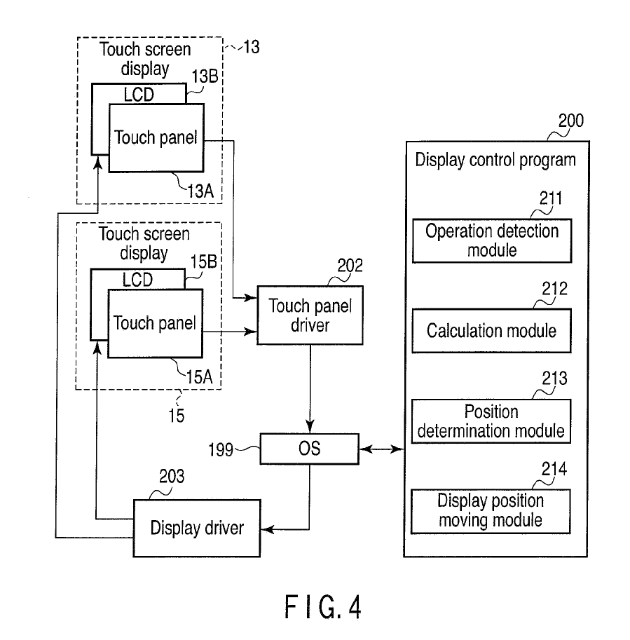

Next, referring to FIG. 4, the functional structure of the display control program 200 in the embodiment is described.

The display control program 200 receives touch position information, which is indicative of a touch position on the touch panel 13A, 15A, via the touch panel driver 202 and the OS 199. Based on the touch position information, the display control program 200 executes display control for moving the display position of an object, such as the window 23, within the entire region in which the screen region of the touch screen display 13 and the screen region of the touch screen display 15 are combined.

The display control program 200 includes, as function executing modules, an operation detection module 211, a calculation module 212, a position determination module 213 and a display position moving module 214.

The operation detection module 211 detects a touch operation on the object displayed on the LCD 13B, 15B, based on the touch position information of the touch panel 13A, 15B, which is input via the OS 199. The operation detection module 211 detects, for example, a flick operation on the object, a touch operation on a button (display position change button) which is provided on the object, or a touch operation indicating the halt of the movement of the object, the display position of which is being moved in accordance with the flick operation.

The calculation module 212 calculates the destination of movement of the object, in accordance with the touch operation detected by the operation detection module 211. When a flick operation has been performed on the object, the calculation module 212 calculates the distance of movement in accordance with the direction and intensity of the flick.

The position determination module 213 determines whether the destination of movement of the object, which is calculated by the calculation module 212, is on a boundary between the screen region of the touch screen display 13 and the screen region of the touch screen display 15. In addition, the position determination module 213 determines whether another object is displayed at the destination of movement of the object.

The display position moving module 214 moves, via the OS 199, the display position of the object within the entire region in which the screen region of the touch screen display 13 and the screen region of the touch screen display 15 are combined. In accordance with the touch operation on the object, for example, in accordance with the direction indicated by the touch operation, the display position moving module 214 moves the display position of the object within the region in which a first screen region of the touch screen display 13 and a second screen region of the touch screen display 15 are combined. The display position moving module 214 can use the following control methods (1) to (7) as the control methods of moving the display position of the object: (1) to move the object to an end of the screen region of the touch screen display 13 or to an end of the screen region of the touch screen display 15, in accordance with the direction designated by the touch operation (first control method); (2) to display the object, for example, at a position on the touch screen display 15, which is associated with the position at which the object is displayed on the touch screen display 13, for example, at the same position on the coordinate systems of the first screen region and the second screen region (display change (second control method)); (3) to move the object by a distance which is calculated by the calculation module 212 in accordance with the intensity of the flick operation (third control method); (4) to move the entire object to either the first screen region or the second screen region, when the position determination module 213 has determined that the destination of movement corresponding to the distance calculated in accordance with the intensity of the flick operation is on a boundary between the first screen region and the second screen region (fourth control method); (5) to change (e.g. maximize) the display size of the object and stop the movement, in the case where the object reaches the end of the first screen region or the end of the second screen region before the object is moved by the distance corresponding to the intensity which is calculated in accordance with the intensity of the flick operation (fifth control method); (6) to change the display position of the object, for example, so that none of objects is hidden, in accordance with the position of other objects displayed at the destination of movement of the object (sixth control method); and (7) to stop, if an instruction for stopping the object is input while the display position of the object is being successively changed, the movement of the object in accordance with this input (seventh control method).

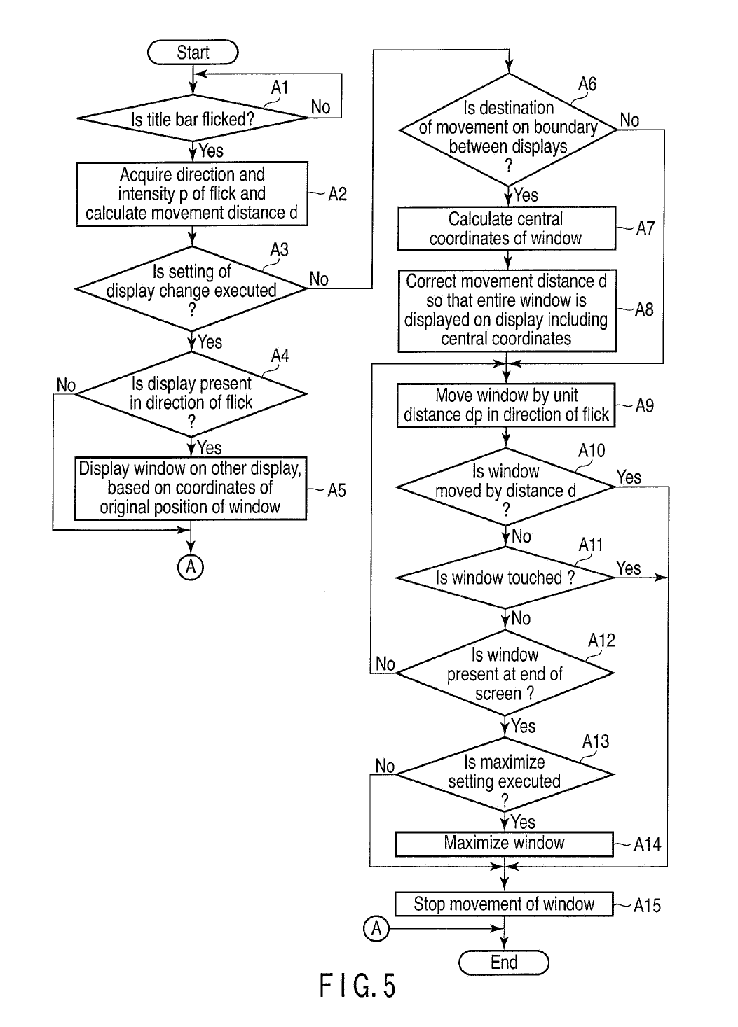

Next, referring to a flow chart of FIG. 5, a description is given of a display control process in the embodiment.

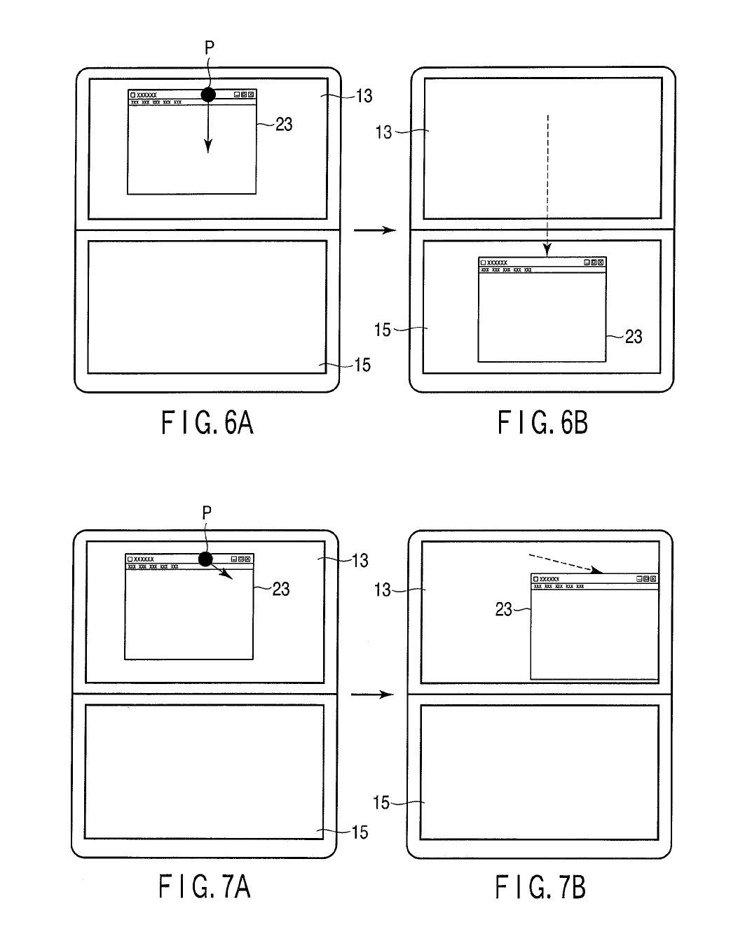

The case of changing the display position of the window 23, which is displayed on the touch screen display 13 or touch screen display 15, is described by way of example. For example, as shown in FIG. 6A, it is assumed that the window 23 is displayed on the touch screen display 13.

As described above, a plurality of control methods are prepared as the control methods for moving the display position of the object by the display control program 200 (display position moving module 214). By receiving an instruction from a user in advance, the display control program 200 can execute setting as to which of the control methods is to be enabled.

To begin with, a description is given of examples in which the second, third, fourth, fifth and seventh control methods are set to be enabled.

Assume now that the title bar 23a of the window 23 has been touched and a flick operation has been performed in the direction of the touch screen display 15. The display control program 200 inputs, via the touch panel driver 202 and the OS 199, touch position information corresponding to the flick operation on the window 23 (title bar 23a).

If the operation detection module 211 detects, based on the touch position information, the flick operation on the title bar 23a of the window 23, the operation detection module 211 instructs the calculation module 212 to calculate the direction and intensity of the flick operation (block A1).

Using the position (point P in FIG. 6A), which is first touched in the flick operation, as the origin, the calculation module 212 calculates the direction, based on the origin and a position at which the touch is released. In addition, the calculation module 212 calculates, as the intensity of the flick operation, the reciprocal of the time period from the first touch of the flick operation to the release of the touch. The intensity of the flick operation can be restated as the speed of the flick. Thus, if the flick operation is finished in a shorter time, the intensity of the flick operation is higher.

Next, based on the direction and intensity p of the flick operation, the calculation module 212 calculates the movement distance d of the window 23 (block A2). The calculation module 212 calculates the movement distance d, based on a function (d=f(p)) which is prepared in advance, with the intensity p of the flick operation being used as the input. The function f(p) is, for example, such a function that an output value d becomes greater in proportion to an input value p. In short, as the intensity of the flick operation is higher, the movement distance d of the window 23 becomes longer. In the meantime, use may be made of a function other than the function by which the movement distance d becomes greater in proportion to the intensity p of the flick operation. For example, the value of the weighting factor may be varied stepwise between the case where the intensity p of the flick operation is high and the case where the intensity p of the flick operation is low, and thereby the movement distance corresponding to the intensity of the flick operation may be varied.

When the display change (second control method) is not set (No in block A3), the position determination module 213 determines whether the destination of movement of the window 23, which is indicated by the movement distance d calculated by the calculation module 212, is on a boundary between the screen regions of the touch screen displays 13 and 15. If it is determined that the destination of movement of the window 23 is not on the boundary (No in block A6), the display position moving module 214 requests the OS 199 to move the window 23 in the direction of the flick operation by a unit distance dp (block A9). Thereby, the window 23 begins to move in the direction of the flick operation. Until moving the window 23 by the movement distance d (No in block A10), the display position moving module 214 successively moves the window 23 in units of the unit distance dp (block A9). In other words, the display position moving module 214 moves the display position of the window 23 at a fixed speed.

The speed of movement of the window 23 may be set to be high so that instantaneous movement may be recognized in accordance with the flick operation, or may be set at such a low speed that the variation of the display position of the window 23 may be recognized. Besides, the speed of movement of the window 23 may be varied such that the speed is high immediately after the flick operation is performed, and then becomes gradually lower thereafter. Like the setting of the control method, the speed of movement of the window 23 may be set by the reception of an instruction from the user.

If the display position moving module 214 has moved the window 23 by the movement distance d (Yes in block A10), the display position moving module 214 stops the movement of the window 23 (block A15) (third control method).

For example, as shown in FIG. 6A, when a flick operation has been performed on the window 23 in the direction of the touch screen display 15, the display position of the window 23 is moved in the direction of the flick operation, as shown in FIG. 6B. In the example shown in FIG. 6B, the display position of the window 23 is moved to the second screen region of the touch screen display 15. The display position moving module 214 can use the first screen region of the touch screen display 13 and the second screen region of the touch screen display 15 as a single screen region, and can move the window 23 beyond the logical boundary between the first screen region and the second screen region.

For example, as shown in FIG. 7A, when a flick operation has been performed on the window 23 displayed on the touch screen display 13, not in the direction of the touch screen display 15, but in the direction of the right end of the touch screen display 13, the window 23 is moved within the first screen region of the touch screen display 13 in accordance with the direction of the flick operation.

When the window 23 reaches the end of the screen region of the touch screen display 13, 15 before the window 23 is moved by the movement distance corresponding to the intensity of the flick operation (Yes in block A12), if the maximize setting (the setting of the fifth control method) is not executed (No in block A13), the display position moving module 214 stops the window 23 at the position where the window 23 has reached the end of the first screen region or the end of the second screen region (block A15).

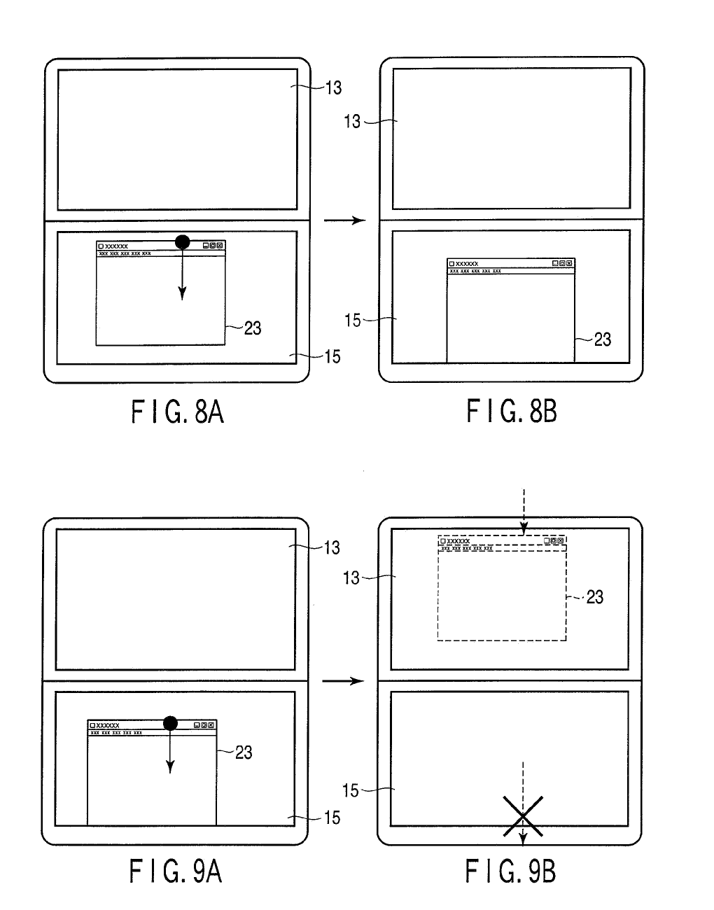

For example, as shown in FIG. 8A, when a downward flick operation is performed on the window 23 displayed on the touch screen display 15, the window 23 reaches the lower end of the screen region of the touch screen display 15 since the movable distance of the window 23 is short. In this case, as shown in FIG. 8B, the display position moving module 214 stops the movement of the window 23 at a time point when the window 23 has reached the end of the screen region.

As shown in FIG. 6A and FIG. 6B, the display position moving module 214 moves the display position of the window 23 beyond the boundary between the screen regions of the touch screen displays 13 and 15. However, the display position moving module 214 does not move the window 23 beyond the other ends of the screen boundary.

Thus, even if a downward flick operation has been performed on the window 23 which is displayed at the lower end of the touch screen display 15, as shown in FIG. 9A, the display position moving module 214 does not execute display control to move the window 23 from above the touch screen display 13, as shown in FIG. 9B.

There is a case in which the resolution of the touch screen display 13 (LCD 13B) and the resolution of the touch screen display 15 (LCD 15B) are set at different values by the OS 199. For example, FIG. 10A and FIG. 10B show the state in which the resolution of the touch screen display 13 and the resolution of the touch screen display 15 are different.

As shown in FIG. 10A, when a flick operation has been performed on the window 23 displayed on the touch screen display 15, in an upward direction in which the screen region of the touch screen display 13 is logically disposed, the display position moving module 214 moves a window 23d to the touch screen display 13, as shown in FIG. 10B, if the entirety of the window 23 can pass the logical boundary between the touch screen displays 13 and 15.

On the other hand, if the entirety of the window 23 cannot pass the logical boundary due to the difference in resolution when the window 23 is moved in accordance with the direction of the flick operation, the display position moving module 214 stops a window 23c at the position where the window 23c reaches the boundary, as shown in FIG. 10A.

In the above description, the screen regions of the touch screen displays 13 and 15 are arranged in the up-and-down direction and are managed as the logically single screen region. Alternatively, the OS 199 can execute such setting that the screen regions of the touch screen displays 13 and 15 are arranged in the right-and-left direction. For example, such setting of arrangement is executed that the right end of the first screen region by the touch screen display 13 and the left end of the second screen region by the touch screen display 15 are located at the boundary, the window 23 can be moved between the touch screen displays 13 and 15 by a flick operation in a right-and-left direction. For example, if a rightward flick operation is performed on the window 23 displayed on the touch screen display 13, the display position moving module 214 moves the window 23 from the left side of the touch screen display 15, beyond the boundary between the first screen region and the second screen region. In this case, since the upper and lower ends of the touch screen display 13, 15 are the ends of the screen region, even if a flick operation is performed on the window 23 in the up-and-down direction, the window 23 is not moved beyond the ends of the screen region.

If the maximize setting (the setting of the fifth control method) is executed (Yes in block A13), the display position moving module 214 requests the OS 199 to maximize the window 23 when the window 23 has been moved to the end of the first screen region or second screen region, and stops the window 23 (block A14) (fifth control method).

For example, as shown in FIG. 11A, if a downward flick operation is performed on the window 23 displayed on the touch screen display 15 and the window 23 reaches the lower end of the touch screen display 15, a window 23b is maximized and displayed on the touch screen display 15, as shown in FIG. 11B. If a flick operation is performed in the direction of the touch screen display 13 and the window 23 reaches the end of the screen region of the touch screen display 13, the window 23 is maximized and displayed on the touch screen display 13.

When a touch operation on the window 23 is detected by the operation detection module 211 (Yes in block A11) while the display position of the window 23 is successively changed (block A9, A10), the display position moving module 214 stops the movement of the window 23 at a time point when the touch operation has been performed (block A15). Thereby, after instructing the movement of the window 23 by the flick operation, the window 23 can be stopped at an arbitrary position during the movement (seventh control method).

If the display change (second control method) is not set (No in block A3) and it is determined that the destination of movement of the window 23 is on the boundary between the screen regions of the touch screen displays 13 and 15 (Yes in block A6), the calculation module 212 calculates the central coordinates at the destination of movement of the window 23, based on the direction of movement of the window 23, the movement distance d and the size of the window 23 (block A7).

Then, the calculation module 212 determines whether the central coordinates at the destination of movement of the window 23 are included in the screen region of the touch screen display 13 or in the screen region of the touch screen display 15, and corrects the movement distance d so that the entirety of the window 23 may be displayed in the screen region including the central coordinates (block A8).

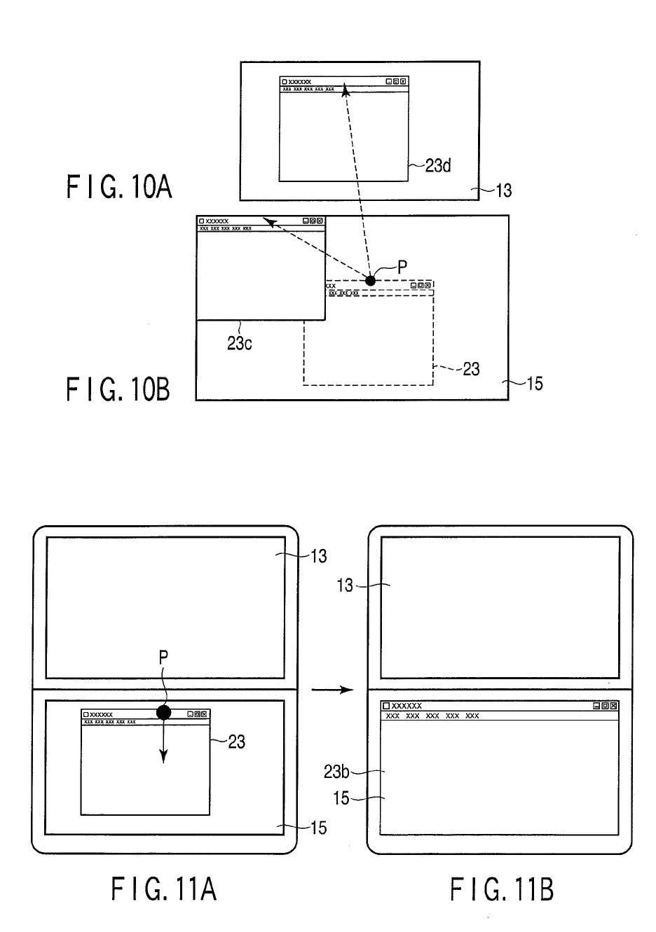

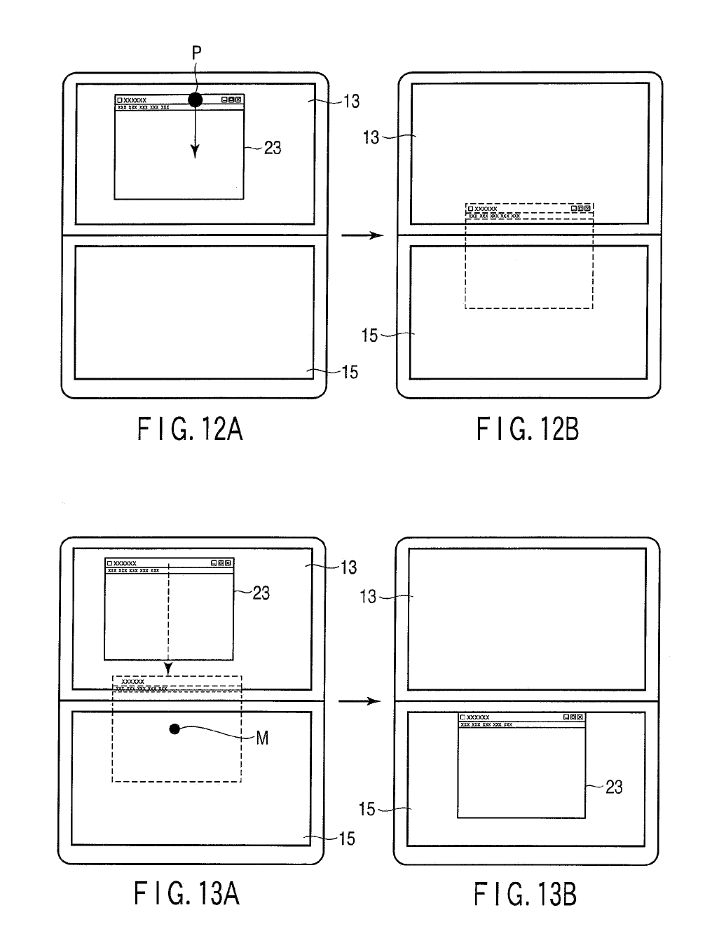

For example, assume now that when a flick operation is performed on the window 23 displayed on the touch screen display 13, as shown in FIG. 12A, the destination of movement, which is calculated based on the direction and intensity of the flick operation, is on the boundary between the touch screen display 13 and 15, as shown in FIG. 12B.

In this case, as shown in FIG. 13A, central coordinates M at the destination of movement of the window 23 are calculated, and it is determined whether the central coordinates M are included in the touch screen display 13 or in the touch screen display 15. In the example shown in FIG. 13A, the central coordinates M of the window 23 are included in the screen region of the touch screen display 15. Thus, the calculation module 212 calculates and corrects the movement distance d from the display position shown in FIG. 12A to the display position shown in FIG. 13B, so that the entirety of the window 23 may be displayed on the touch screen display 15, as shown in FIG. 13B.

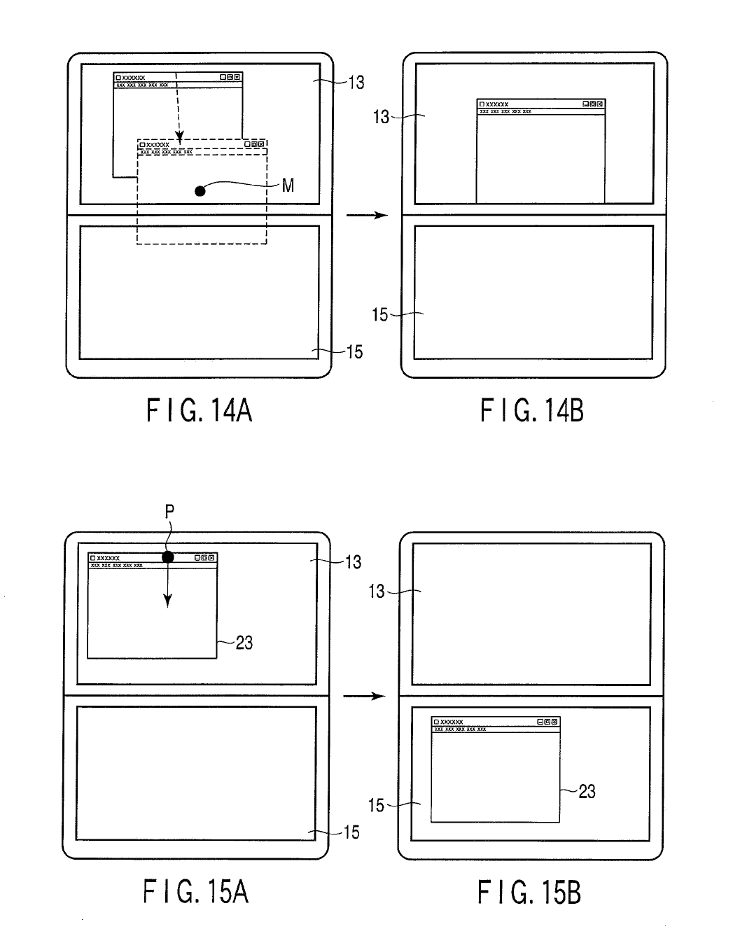

Similarly, when the central coordinates M at the destination of movement of the window 23 are included in the screen region of the touch screen display 13, as shown in FIG. 14A, the movement distance d is corrected so that the entirety of the window 23 may be displayed on the touch screen display 13, as shown in FIG. 14B.

Based on the corrected movement distance d, the display position moving module 214 moves the display position of the window 23, as described above (blocks A9 to A12).

When the display change (second control method) is set (Yes in block A3), the display position moving module 214 determines whether a touch screen display, which is different from the touch screen display on which the window 23 is currently displayed, is present in the direction of the flick operation. If the touch screen display is present in the direction of the flick operation, the display position moving module 214 displays the window on this other touch screen display, based on the coordinates of the original position of the window 23 (block A5).

For example, as shown in FIG. 15A, if a downward flick operation is performed when the window 23 is displayed on the touch screen display 13, the window 23 is moved to the touch screen display 15, as shown in FIG. 15B. At this time, the window 23 is displayed at that position of the other touch screen display 15, which is associated with the position at which the object is displayed on the touch screen display 13.

In the example shown in FIG. 15A and FIG. 15B, the window 23 is moved so that the position of the window 23 in the coordinate system of the first screen region may become identical to the position of the window 23 at the destination of movement in the coordinate system of the second screen region.

Thereby, when the display position of the window 23 is to be moved by performing a flick operation on the window 23 displayed on the touch screen display 13, the destination of movement can easily be estimated.

In the example shown in FIG. 15A and FIG. 15B, the window 23 is moved such that the position of the start of movement and the position of the destination of movement are the same in the touch screen displays 13 and 15. Alternatively, the relationship between the position of the start of movement and the position of the destination of movement may be set in advance. For example, the window 23 may be moved to a position which is fixed regardless of the position of the start of movement, or the window 23 may be moved to a position which is set in advance in accordance with the region (e.g. a right half part or a left half part) including the original display position.

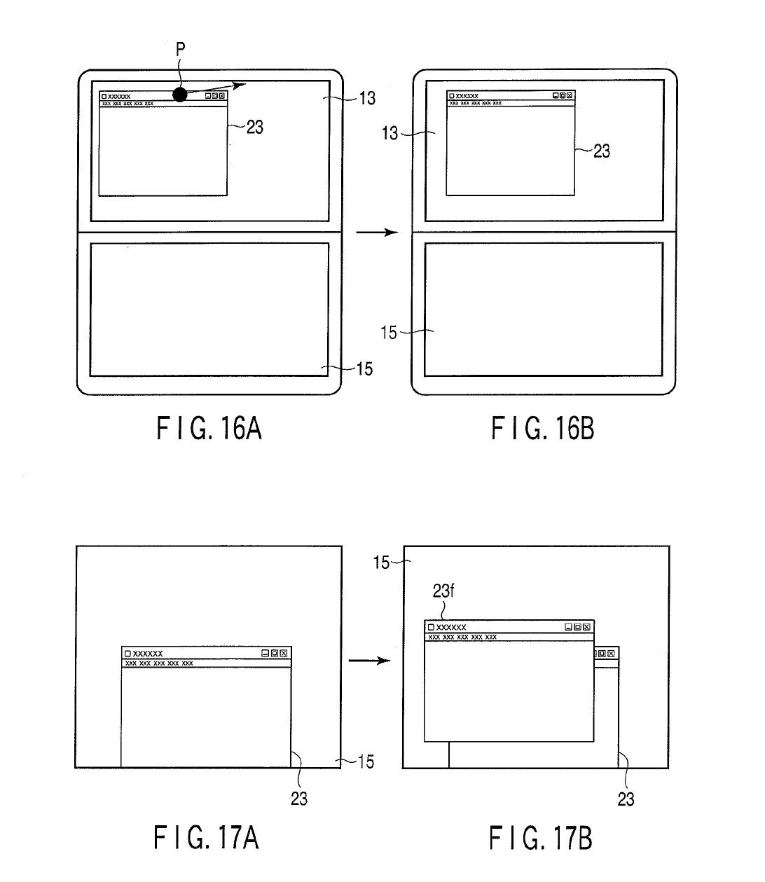

When a flick operation is performed on the window 23 displayed on the touch screen display 13 in a lateral direction, as shown in FIG. 16A, the window 23 is not moved in response to the flick operation, as shown in FIG. 16B, since the touch screen display 15 is not disposed in the lateral direction.

In the above description, the window 23 is moved by the distance which is calculated in accordance with the intensity of the flick operation on the window 23. However, when the first control method is set, it is possible to move the window 23 in accordance with only the direction of the flick operation.

For example, in accordance with the direction of the flick operation, which is calculated by the calculation module 212, the display position moving module 214 moves the window 23 until the window 23 reaches the end of the first screen region of the touch screen display 13 or to the end of the second screen region of the touch screen display 15. In this case, the window 23 can be moved beyond the logical boundary between the first screen region and second screen region, but the window 23 is not moved beyond the ends other than the logical boundary between the first screen region and second screen region, as shown in FIG. 9A and FIG. 9B.

In the above description, when the window 23 is moved to the end of the screen region, the movement is stopped at the position where the entirety of the window 23 (object) is displayed. However, if at least a part of the region (e.g. title bar 23a), which is manipulated in order to move the display position of the window 23, is displayed, the window 23 may be moved to a position where a part of the window 23 is hidden.

Thereby, the display position of the window 23 is changed by the flick operation, and it becomes possible to reduce the region where the window 23 is displayed, and to easily enlarge the area where other objects can be displayed.

In the above description, the window 23 is moved to the end of the screen region of the touch screen display 13, 15. However, when the sixth control method is set, the destination of movement can be adjusted in accordance with another object displayed at the destination of movement. For example, the destination of movement is changed so that none of objects may be hidden by the window 23 by the movement of the window 23.

For example, assume now that a flick operation has been performed to move a window 23f, which is displayed on the touch screen display 13, to the end of the touch screen display 15. As shown in FIG. 17A, a window 23 is already displayed at the lower end of the touch screen display 15. In this case, the display position of the window 23f is adjusted so that the entirety of the window 23 may not be hidden by the window 23f. Preferably, a part of the title bar 23a, which is manipulated in order to change the display position of the window 23, should be displayed. In the adjustment of the display position, the movement may be stopped before reaching the end of the screen region, or such a position as to prevent complete overlap may be calculated based on the display position of an object which exists at the destination of movement and the window may be moved to this position.

Moreover, it is possible to prevent the window 23 from being moved to the touch screen display 15, when a specific object is displayed on the touch screen display 15 at the destination of movement. For example, when a software keyboard is displayed on the touch screen display 15, even if a flick operation is performed to move the window 23, which is displayed on the touch screen display 13, to the touch screen display 15, the movement of the window 23 is stopped at the lower end of the touch screen display 13.

Thereby, the window 23, which is moved by the flick operation, does not deteriorate the operability on other objects.

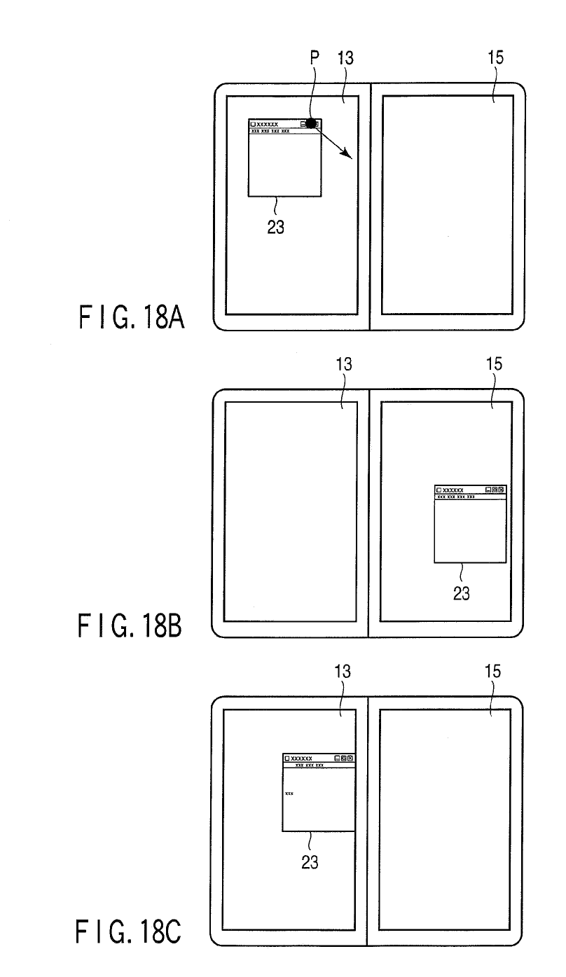

Display control of the window 23, which corresponds to the flick operation, may be executed in accordance with the mode of use of the personal computer 10. In the above-described examples, the personal computer 10 is used in the mode in which the touch screen displays 13 and 15 are arranged in the up-and-down direction. Alternatively, for example, as shown in FIG. 18A, the personal computer 10 may be used in the mode in which the touch screen displays 13 and 15 are arranged in the right-and-left direction.

The OS 199 detects the attitude of the personal computer 10 by the sensor 119, and changes the display direction of the LCDs 13B and 15B in accordance with the arrangement of the touch screen displays 13 and 15.

When a flick operation has been performed on the window 23 in a lower-right direction, as shown in FIG. 18A, the display position of the window 23 is changed, for example, as shown in FIG. 18B, in accordance with the direction and intensity of the flick operation, according to the same display control as described above.

On the other hand, in the case of the mode of use shown in FIG. 18A, FIG. 18B and FIG. 18C, the display control program 200 receives, via the OS 199, data indicative of the mode of use, and restricts the range of movement of the window 23 in accordance with this data. For example, when a flick operation has been performed on the window 23 in a lower-right direction, as shown in FIG. 18A, the movement of the window 23 is stopped at the end of the screen region of the touch screen display 13.

The display control corresponding to the mode of use of the personal computer 10 may arbitrarily be set by the designation from the user. In this case, the above-described first to seventh display controls may arbitrarily be combined and set.

As shown in FIG. 19, the title bar 23a of the window 23 is provided with buttons for instructing a change of the display mode of the window 23, for example, a close button 24a, a Maximize button 24b, a Minimize button 24c, a full-screen display button 25 for displaying the window 23 on the full screen of the touch screen display 13, 15, and a display position change button 26 for changing the display which displays the window 23.

Since the title bar 23a of the window 23 shown in FIG. 19 indicates the case in which the title bar 23a is displayed on the touch screen display 13, the display position change button 26 displays a downward arrow so as to indicate a change of the display position to the touch screen display 15 which is disposed in the downward direction. In the case where the window 23 is displayed on the touch screen display 15, the arrow of the display position change button 26 is changed to an upward arrow. Further, when the personal computer 10 is used in the mode in which the touch screen displays 13 and 15 are arranged in the right-and-left direction, the arrow of the display position change button 26 is changed to a rightward arrow or a leftward arrow, according to whether the window 23 is displayed on the touch screen display 13 or the touch screen display 15.

When a touch on the full-screen display button 25 is detected by the operation detection module 211, the display position moving module 214 displays a window 23e on the entirety of the touch screen displays 13 and 15, as shown in FIG. 20.

When a touch on the display position change button 26 is detected by the operation detection module 211, the display position moving module 214 changes the display position of the window 23 to a touch screen display which is different from the touch screen display on which the window 23 is currently displayed, as in the case where the above-described display change (second control method) is set.

In the above description, when the display position of the window 23 reaches the end of the screen region, the movement of the window 23 is stopped (the control methods other than the sixth control method). However, the end of the screen region may be set, not only at the end of the physically displayable entire region, but also at the end of a position with a predetermined margin.

As has been described above, in the present embodiment, the display position of the window 23 can be moved by the flick operation. In this case, by associating the intensity of the flick operation with the movement distance of the window 23, the destination of movement can intuitively be understood.

In the personal computer 10 which is provided with the plural touch screen displays 13 and 15, since the touch screen displays 13 and 15 are physically separated, an object cannot be moved beyond the boundary of the screen regions by a drag by a touch operation. However, by the flick operation, the movement beyond the touch screen display 13, 15 can easily be executed.

In the above description, the display position of the window 23 is moved by the flick operation. However, aside from the window 23, a software keyboard, a software touch pad, icons representing folders and files, menus and buttons can be moved.

The process that has been described in connection with the above-described embodiment may be stored, as a program which can be executed by a computer, in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first touch screen display;
a second touch screen display;
a detector configured to detect a touch operation associated with a direction of motion; and
a moving module configured to move a first object's display position based on the direction of motion associated with the touch operation, the moving module moving the display position within a combined region, the combined region comprising a first screen region of the first touch screen display and a second screen region of the second touch screen display.

2. The electronic apparatus of claim 1, wherein the moving module is configured to move the first object to an end of the first screen region or to an end of the second screen region in accordance with the moving direction.

3. The electronic apparatus of claim 2, wherein the moving module is configured to change the display position of the first object if a second object is displayed at a movement destination of the first object.

4. The electronic apparatus of claim 1, wherein the moving module is configured to move the first object from a position on the first touch screen display to a position on the second touch screen display.

5. The electronic apparatus of claim 4, wherein:
the touch operation is a flick operation;
the detector is configured to detect a direction and an intensity of the flick operation; and
the moving module is configured to move the first object by a distance based on the intensity.

6. The electronic apparatus of claim 5, wherein the moving module is configured to move the first object to a position on either the first screen region or the second screen region, so that the first object is fully displayed on either the first screen region or the second screen region, if a movement destination of the first object is on a boundary between the first screen region and the second screen region.

7. The electronic apparatus of claim 5, wherein the moving module is configured to change a display size of the first object if the first object reaches an end of the first screen region or an end of the second screen region before the first object is moved the distance corresponding to the intensity.

8. The electronic apparatus of claim 5, wherein the moving module is configured to change the display position of the first object if a second object is displayed at a movement destination of the first object.

9. The electronic apparatus of claim 1, wherein the moving module is configured to successively move the display position of the first object from an original position to a movement destination.

10. The electronic apparatus of claim 9, further comprising an input detector configured to detect an input while the first object is being moved,
wherein the moving module is configured to stop movement of the first object if the input is detected by the input detector.

11. A display control method of an electronic apparatus including a first touch screen display and a second touch screen display, the method comprising:
detecting a touch operation associated with a direction of motion; and
moving a display position of an object, based on the direction of motion, within a combined region, the combined region comprising a first screen region of the first touch screen display and a second screen region of the second touch screen display.
